(19) United States
(12) Patent Application Publication
(10) Pub. No.: US 2015/0168151 A1
(43) Pub. Date: Jun. 18, 2015

(54) CLOUD SYSTEM FOR A VEHICLE

(71) Applicant: HYUNDAI MOTOR COMPANY, Seoul (KR)

(72) Inventors: Ji-Hyun LIM, Suwon-si (KR); Yong KIM, Inchun-shi (KR)

(21) Appl. No.: 14/543,890

(22) Filed: Nov. 17, 2014

(30) Foreign Application Priority Data
Dec. 18, 2013 (KR) 10-2013-158593

(51) Int. Cl. G01C 21/00; H04L 29/08; G06F 17/30

(52) U.S. Cl. CPC G01C 21/00; G06F 17/30241; H04L 67/10; H04L 67/18; H04L 67/12

(57) ABSTRACT

A cloud system is provided for a vehicle in which a terminal is equipped to transmit information to a driver, and is adapted to communicate with a cloud server. The cloud server builds contents including a user experience (UX) on the server, and provides the contents to be displayed by the terminal. Moreover, the cloud server can provide simultaneously a plurality of contents to a plurality of terminals in communication with the cloud server. The contents are updated through an update of a database (DB) of the cloud server, which does not require a separate update of an additional DB on the driver side.

### CROSS-REFERENCE TO RELATED APPLICATION

This application claims under 35 U.S.C. §119a the benefit of Korean Patent Application No. 10-2013-158593 filed on Dec. 18, 2013, the entire contents of which are incorporated herein by reference.

### TECHNICAL FIELD

The present disclosure relates to a cloud system for a vehicle, and more particularly, to a cloud system for a vehicle in which a terminal is equipped in the vehicle as to transmit information to a driver is adapted to communicate with a cloud server, and the cloud server builds all contents including a user experience (UX) on the server and provides only information to be displayed to the terminal, thereby making it possible to provide the same contents to a plurality of terminals in communication with the cloud server, and the contents are updated through an update of a database (DB) of the cloud server, which does not require a separate update of the DB on the user side.

### BACKGROUND

In general, navigation systems installed in a vehicle to allow real-time route guidance to a destination that a driver of the vehicle tries to go have been widely used.

The above-described navigation systems are known devices that store and build large capacities of map information and road information as a DB so that the retrieval thereof can be performed, recognize the current position via communication with satellites including a global positioning system (GPS) module, and perform matching of the recognized current position with the map information and the road information that are built as the DB, and guide the route from the current position to the destination set by the driver in real time.

Meanwhile, in the above-described navigation systems, in recent years, various types of information provided for the convenience of the driver have gradually been diversified.

For example, by including more information when building the map information and the road information so as to improve visual satisfaction and visibility of the driver, images provided via the navigation systems have become more and more detailed. In other words, various information provided by the navigation systems have been formed so that the stored map information and road information are imaged and displayed on a display, and the various information have been developed so that there are increased images of the DB that is built so as to be able to feel homogeneity by making the images provided to the driver with the above-described information similar to the actual information. Furthermore, in recent years, the map information and the road information that are built in the above-described navigation system have developed to a step of more realistically displaying the information by converting the information into a three dimension (3D) display.

Further, the above-described navigation systems also additionally provide the traveling routes and tourist information near the destination during the route guidance to the destination so as to improve the convenience of the driver, and therefore, the DB of the map information and the road information have the increasingly large capacities.

Accordingly, along with the development of the above-described navigation systems, in order to build the DB of the map information and the road information of large capacities, retrieve the information to be displayed from the DB of the large capacity, and reconstruct the images, there has been a need to mount a central processing unit (CPU) having an information processing performance of high specification on the navigation. Since mounting of the CPU with the high specification and building the DB with the large capacity should be necessarily accompanied by an increase in costs, there has been a drawback to increasing the overall manufacturing cost of the navigation system.

Meanwhile, the DB of the map information and the road information that are built in the navigation system requires the continuous updates so as to reflect the ever-changing modifications. However, since in the DB of the map information and the road information, in which the capacities have increasingly risen as described above, large capacities of information need to be exchanged to update the information, there has been a drawback in that an increase in costs and an increase in inconvenience associated with the update of the information are accompanied. In particular, since the time required for information updating increases in proportion as the capacity of the map information DB increases, a solution to minimize this has been required.

As a technique to prevent the drawbacks as described above, the following techniques have been known.

U.S. Pat. No. 6,175,789 has a configuration in which a computer system having an open platform is mounted on a vehicle, applications are installed in the computer system and are operated by the navigation system, and the computer system communicates with a server and displays the contents received from the server. Thus, since the contents are provided from the server, there is no need for building the large capacities of DB as described above, thereby solving the problems of increased cost and time as described above.

However, the related art described above builds the navigation system via the computer system having the open platform, but in terms of merely receiving the contents from the server to rebuild the information stored on the computer system, and in terms of requiring the information processing capability of high specification as information to be displayed increases, it cannot solve all the problems of the related art.

Furthermore, in the above-described related art, a UX (User experience) configuration (a user interface, a sound, a screen or the like) provided for the user is also configured to be provided by being built on the computer system, and such a configuration is limited to a configuration that is built on the application to be installed, and since the configuration built during the installation is maintained, there is no choice but to become an old design after predetermined periods of time (several years). In addition, since the applications capable of being installed according to an operating system (OS) of the computer system are limited, there is a drawback in that it is difficult to apply the quickly changing new techniques. Thus, unless the same UX configuration is replaced with a new navigation system, since the drivers continuously use the navigation system, there is a drawback in that the drivers can feel tedium.

The above-described drawbacks of the conventional navigation systems are not limited only to their navigation systems, and are also similarly applied to a telematics system equipped in the vehicle to provide information to the user. Accordingly, there is a need for measures for solving these drawbacks.

### SUMMARY OF THE DISCLOSURE

Disclosed herein is a cloud system for a vehicle in which a terminal equipped in a vehicle so as to transmit information to a driver is adapted to communicate with a cloud server, and the cloud server builds all contents including UX on a server and provides only information to be displayed to the terminal, thereby providing the same contents to a plurality of terminals in communication with the cloud server, and the contents are updated through an update of a DB of the cloud server, which does not require a separate update of the DB on the user side.

In accordance with an exemplary aspect of the present disclosure, there is provided a cloud system for a vehicle which includes a terminal that includes a display, an input, and a communication system and is installed in a vehicle; and a cloud server that includes a database (DB) for storing a UX information and a communication system, wherein the terminal and the cloud server are adapted to wirelessly communicate with each other via the communication system, the cloud server generates contents including the UX information and transmits the contents to the terminal, and the terminal is adapted to display the transmitted contents.

In another exemplary aspect, the terminal further includes a position recognition system, the database of the cloud server is configured to further include a map information. The terminal generates a current position information via the position recognition system and transmits the generated current position information to the cloud server via the communication system. The cloud server retrieves a map information corresponding to the received current position information from the database, generates contents including the map information and the UX information corresponding to the current position information, and transmits the contents to the terminal.

In another exemplary aspect, when a destination information is input through a input unit, the terminal transmits the current position information and the destination information to the cloud server, and the cloud server retrieves information corresponding to the current position information and the destination information from the map information stored in the DB of the cloud server to generate a route information, and transmits the contents to the terminal by including the route information in the contents.

In another exemplary aspect, the cloud server further includes a virtualization agent system, the communication system of the cloud server is configured to communicate with a plurality of terminals, and the virtualization agent system is configured to virtualize the cloud server, generate and provide contents corresponding to each of the plurality of terminals.

In another exemplary aspect, the terminal further includes a database, and is configured to store the contents received from the cloud server.

The present disclosure having the above-described configuration has the following effects:

1) Since the contents provided by one cloud server can be used when being received by a plurality of terminals, a storage for storing the contents does not need to be equipped in the terminals installed in each vehicle, thereby reducing the manufacturing costs of the terminals.

2) According to a configuration in which all the contents to be provided to users including the UX are built in the cloud server and are transmitted to the terminal of the user via the communication network, and the terminal uses the provided contents, a high-performance information processing is not required, thereby reducing the manufacturing costs of the terminals.

3) Unlike the conventional navigation system in which is equipped a storage means, and the user should directly update the stored navigation contents, since the terminal provided by the present disclosure is configured to display only the contents provided from the cloud server, and a building of the contents including the UX is performed in the cloud server, there is provided an advantage of easy expandability for performing the same information provision service through all the devices including a component for displaying the built contents.

### BRIEF DESCRIPTION OF THE DRAWINGS

The above and other features of the present disclosure will now be described in detail with reference to certain exemplary implementations thereof illustrated by the accompanying drawings which are given hereinbelow by way of illustration only, and thus are not limitative of the present disclosure, and wherein:

FIG. 1 shows a schematic diagram according to a preferred implementation of a cloud system for a vehicle of the present disclosure;

FIG. 2 is a block diagram showing an internal configuration of a terminal that is equipped in the vehicle and communicates with the cloud server;

FIG. 3 is a block diagram schematically showing an internal structure of the terminal and the cloud server of FIG. 1;

FIG. 4 is a schematic diagram illustrating synchronization between a plurality of terminals and the cloud server via a virtualization agent system in accordance with the present disclosure; and

FIG. 5 illustrates a data processing process between the cloud server and the terminal according to a preferred implementation of the present disclosure.

### DETAILED DESCRIPTION OF THE DRAWINGS

The present disclosure relates to a cloud system for a vehicle, and more particularly, to a cloud system for a vehicle in which is equipped a terminal, for transmitting information to a driver, which is adapted to communicate with a cloud server, and the cloud server builds all contents including UX on the server and provides only information to be displayed to the terminal, thereby providing the same contents to a plurality of terminals in communication with the cloud server, and the contents are updated through update of a DB of the cloud server, which does not require a separate update of the DB on the user side.

Hereinafter, preferred implementations of the present disclosure will be described in detail with reference to the drawings.

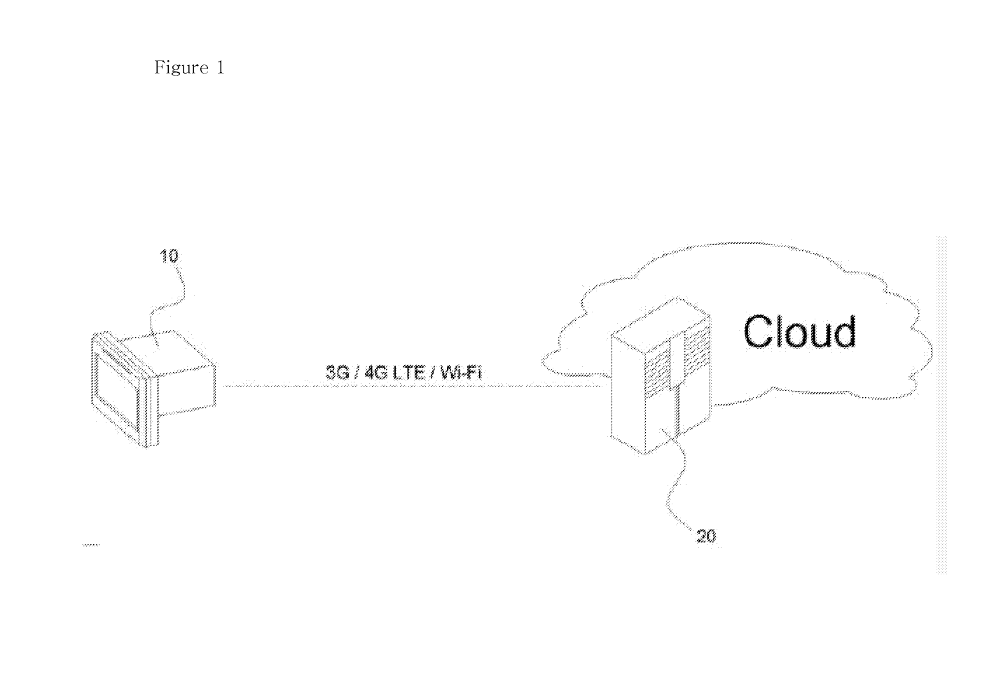

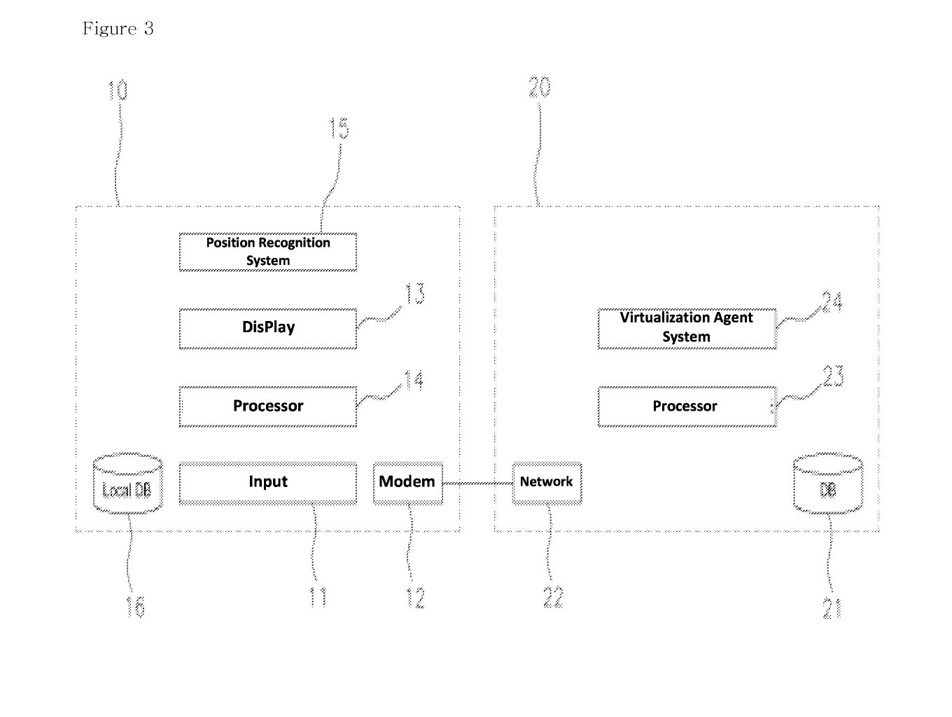

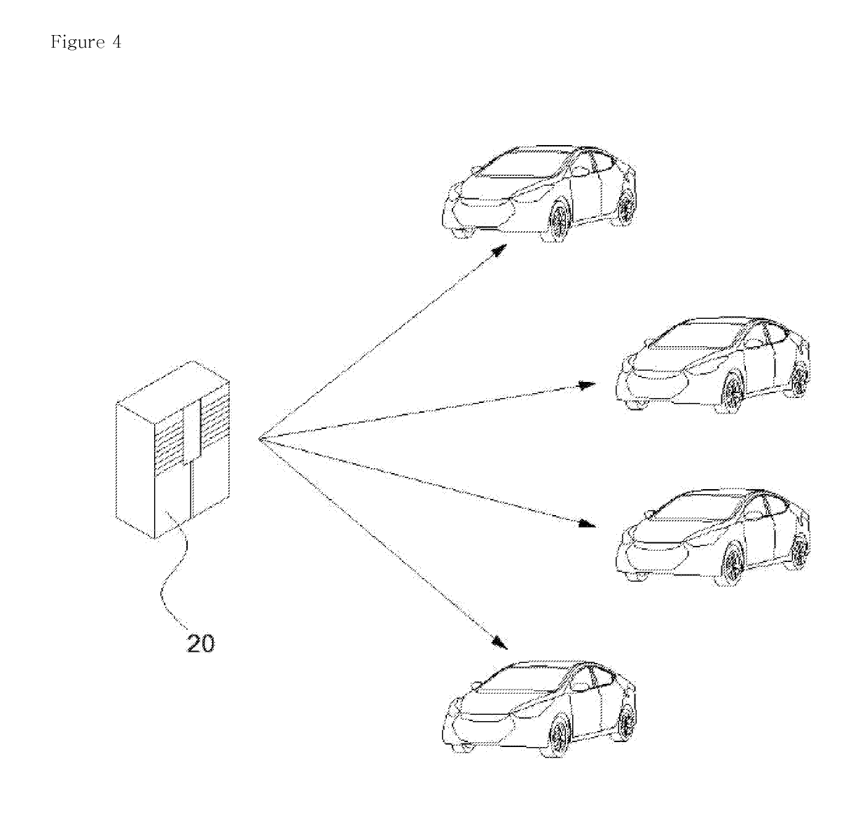

FIG. 1 shows a schematic diagram according to a preferred implementation of a cloud system for a vehicle of the present disclosure and FIG. 2 is a block diagram showing an internal configuration of a terminal 10 that is equipped in the vehicle and communicates with a cloud server 20. Furthermore, FIG. 3 is a block diagram schematically showing an internal structure of the terminal 10 and the cloud server 20 of FIG. 1.

As illustrated, the cloud system for vehicle of the present disclosure is embodied through the communication between the terminal 10 installed in the vehicle and the cloud server 20.

In an exemplary implementation of the present d, the cloud system for a vehicle is described by assuming an example configured to be able to provide all of a route guidance service and an information provision service provided to a driver by a known navigation system via the terminal 10, but such a configuration is only an exemplary implementation of the present disclosure and is not intended to be limited thereto. In another implementation of the present disclosure, only the information provision service in addition to the route guidance service is provided through the cloud system for the vehicle and can be implemented in various combinations without departing from the technical concepts of the present disclosure.

In an exemplary implementation of the present disclosure, the terminal 10 is provided with a communication system 12 to communicate with the cloud server 20 via a wireless communication network, to transmit and receive the data to and from the cloud server 20 The terminal 10 is configured to include a display 13, an input 11, and an processor 14 such as a CPU to display the received data, and is configured to further include a position recognition system 15 for recognizing the position of the installed vehicle, for example, a GPS module.

The terminal 10 may be, for example, a known smart phone, a note book, a tablet PC, an AVN (Audio, Vedio, and Navigation) system or the like, but is not limited thereto, and may be any terminal that includes all the above-mentioned configurations. Accordingly, the terminal 10, which can communicate with the cloud server 20 via the wireless communication network, and can be installed in the vehicle, does not need to be necessarily installed and fixed inside the vehicle. In addition, in a preferred implementation of the present disclosure, when the terminal 10 is configured to provide the route guidance service, which is provided by the known navigation system, the terminal 10 preferably includes the position recognition system 15.

Meanwhile, as a communication between the terminal 10 and the cloud server 20, any known wireless communication network can be applied. Accordingly, a wireless communication network such as a Wi-Fi communication network, and a mobile communication network (for example, 3G and 4G mobile communication networks) may be adopted.

The terminal 10 receives the data from the cloud server 20, primarily saves the data, processes the stored data to be able to be displayed, and displays the data on the display 13. Accordingly, the terminal 10 further includes a database (Local DB) 16. The database 16 may be a memory module that temporarily stores the data, or a data storage module that almost permanently stores the data, but the present disclosure is not limited thereto.

The terminal 10 further includes a speaker module that can output a sound together with the display 13, can be configured to perform the transfer of messages to the driver via sound or voice, and is integrated in the display 13.

As the input 11 of the terminal 10, any known input units such as one or more s, a touch display, and a keyboard can be used. Preferably, in accordance with the present disclosure, an intuitive interface can be provided to the driver by forming the input 11 of the terminal 10 with a touch display.

The processor 14 of the terminal 10 receives the current position information from the position recognition system 15 in real time, and transmits the current position information, together with the destination information that is input from the input 11, to the cloud server 20 via the communication system 12.

Meanwhile, as described above, the cloud server 20 is configured to perform the data communication with the terminal 10 via a known wireless communication network, and accordingly the cloud server 20 is also configured to include a communication system 22 that corresponds to the communication system 12 of the terminal 10). The communication system 12 of the terminal 10 and the communication system 22 of the cloud server 20 are configured to use the same communication protocol.

Furthermore, the cloud server 20 is configured to include a database DB 21 that stores the map information and the road information (hereinafter, unified as “map information”) for a road guidance up to a set destination. Therefore, all the information to be provided through the terminal 10 is provided from the DB 21 of the cloud server 20.

The DB 21 of the cloud server 20 further includes UX information for implementing the user interface. Thus, the processor 23 of the cloud server 20 retrieves the UX information and the map information stored in the DB 21 based on the current position information, and produces the contents (including UX) to be provided to the user through the terminal 10. Further, the cloud server 20 is configured to include the processor 23 for retrieving the information stored in the DB 21 and generating the contents based on this information.

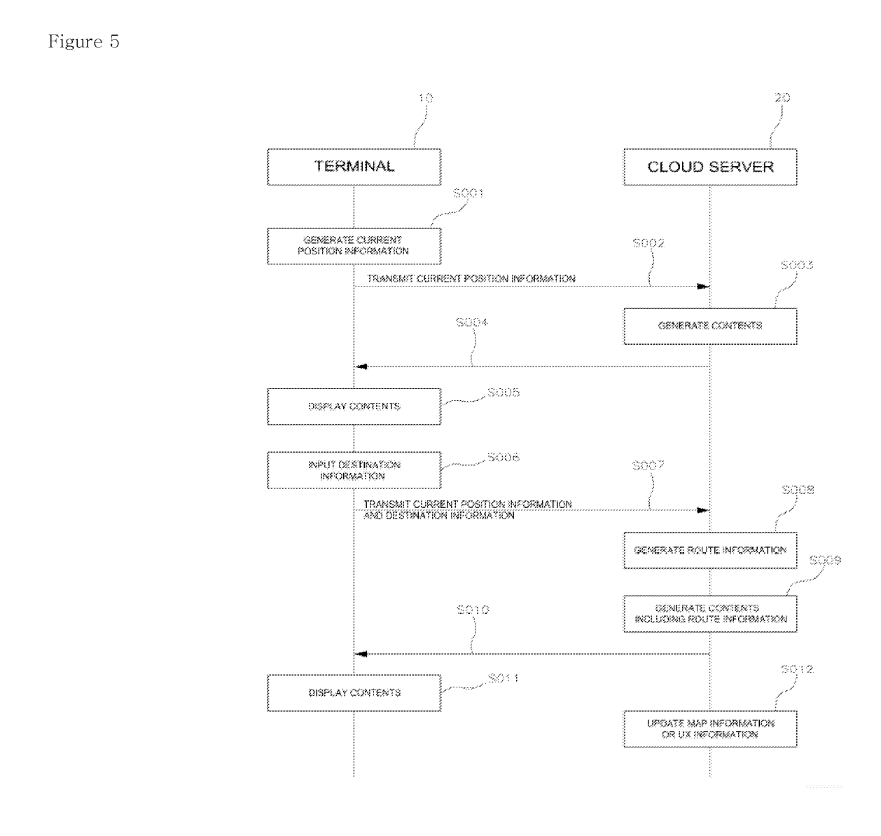

Meanwhile, the cloud server 20 further comprises a virtualization agent system 24. The virtualization agent system 24 is a module that enables synchronization between the cloud server 20 and the plurality of terminals 10 using the cloud technique, and is provided so that the contents provided by the cloud server 20 are supplied to the plurality of terminals 10 at the same time. FIG. 4 is a schematic diagram showing the synchronization between the plurality of terminals 10 and the cloud server 20 via the virtualization agent system 24 as described above. Since the detailed configuration of the virtualization agent system 24 configured as described above includes known technical matters related to the cloud computing technique, a further detailed description will not be provided.

The terminal 10 of the cloud system for vehicle of the preferred implementation of the present disclosure configured as described above provides the user with the same navigation service as any known navigation system. However, because the terminal is configured to perform only functions related to the position recognition, the communication with the cloud server 20, and to the data display, it is possible to reduce the manufacturing cost. Moreover, since the data to be displayed are stored in the cloud server 20, there is an advantage in that there is no need to separately update the data.

Further, in the above-described preferred implementation the cloud server is configured to provide the contents including the route guidance service provided by the navigation system. Moreover in other implementations of the present disclosure, the cloud system for a vehicle can be configured to provide the certain information provision service. For this implementation, the contents include various information provided to the user including the UX information. Moreover, additional arrangements of the cloud system may be formed in the same way as the arrangement of the preferred implementation of the present disclosure.

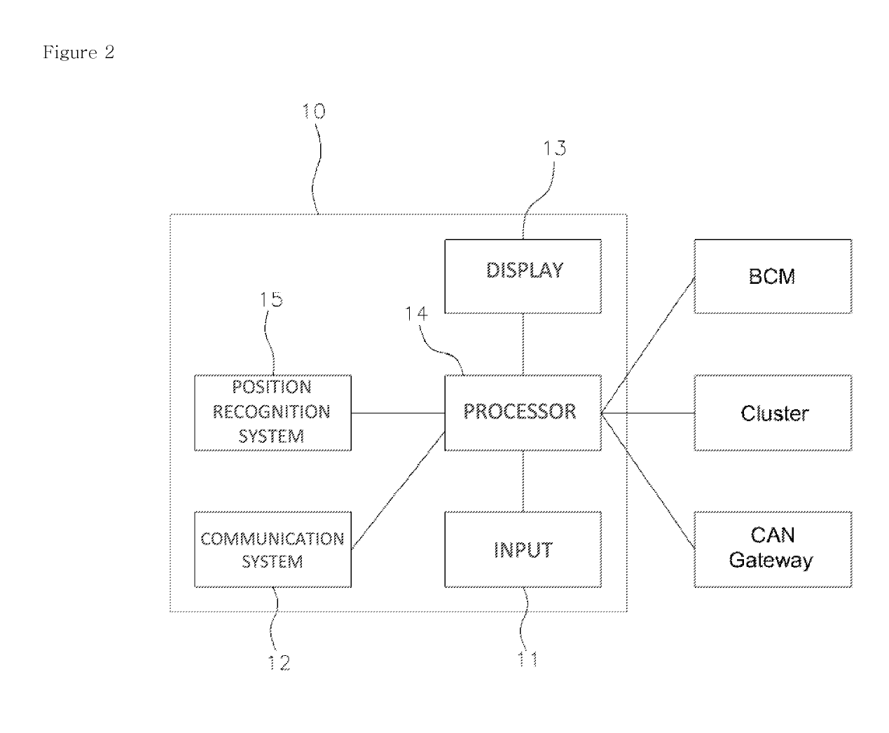

FIG. 5 illustrates a data processing process between the cloud server 20 and the terminal 10 of the preferred implementation of the present implementation configured as described above.

First, when the terminal 10 is activated, the terminal 10 recognizes the current position via the position recognition system 15 to generate the current position information (S001), and transmits the current position information to the cloud server 20 via the communication system 12 (S002).

When the current position information is received from the terminal 10, the cloud server 20 retrieves the information corresponding to the current position information from the map information stored in the DB of the cloud server 20, processes the UX information stored in the DB 21 of the cloud server 20 and the retrieved map information to generate the contents (S003), and transmits the contents to the terminal 10 through the communication system 22 (S004).

The terminal 10 displays the navigation service information via the display 13 when receiving the contents from the cloud server 20 (S005).

In the preferred implementation of the present disclosure, the above-described steps S001 to S005 are configured to be periodically and continuously repeated, until there is no input from the user or the power source is cut off.

Meanwhile, when the destination information is input through the input 11 of the terminal 10 by the user (S006), the terminal 10 recognizes the input destination information through the position recognition system 15 and transmits the input destination information and the generated current position information to the cloud server 20 through the communication system 12 (S007).

When the current position information and the destination information are received from the terminal 10, the cloud server above 20 retrieves the information corresponding to the current position information and the destination information from the map information stored in the DB 21 of the cloud server 20, and generates the route information from the current position to the destination from the retrieved information. Because a route information generation algorithm of any known navigation system is applicable and is a well-known matter, then the description thereof will not be provided) (S008). Furthermore, the cloud server 20 processes the UX information stored in the DB of the cloud server 20 and the route information generated at the above-described step S008 to generate the contents (S009), and transmits the contents to the terminal 10 through the communication system 22 (S010).

The terminal 10 displays the details of the contents via the display 3 when receiving the contents from the cloud server 20 (5011).

Thereafter, the cloud server 20 updates the map information or the UX information stored in the DB of the cloud server 20, if necessary, or updates the contents to be provided to the users (S012).

While the preferred embodiment of the cloud system for the vehicle of the present invention has been described above in detail, this embodiment merely presents the examples specified to aid the understanding of the present invention, and is not intended to limit the scope of the present invention. It will be appreciated by those skilled in the art that other modifications based on the technical concept of the present invention may be practiced in addition to the embodiments disclosed herein.

What is claimed is:

1. A cloud system for a vehicle comprising:
a terminal that includes a display, an input, and a terminal communication system and is installed in a vehicle; and
a cloud server that includes a database (DB) for storing a user experience (UX) information and a server communication system,
wherein the terminal and the cloud server are adapted to wirelessly communicate with each other via their respective communication systems,
the cloud server generates contents including the UX information and transmits the contents to the terminal, and
the terminal is adapted to display the received contents.

2. The cloud system for a vehicle of claim 1, wherein:
the terminal further includes a position recognition system,
the database of the cloud server is configured to further include map information,
the terminal generates a current position information via the position recognition system and transmits the generated current position information to the cloud server via the terminal communication system, and
the cloud server retrieves map information corresponding to the received current position information from the database, generates contents including the map information and the UX information corresponding to the current position information, and transmits the contents to the terminal.

3. The cloud system for a vehicle of claim 2, wherein:
when a destination information is input through an input unit, the terminal transmits the current position information and the destination information to the cloud server, and
the cloud server retrieves information corresponding to the current position information and the destination information from the map information stored in the DB of the cloud server to generate route information, and transmits the contents to the terminal by including the route information in the contents.

4. The cloud system for a vehicle of claim 1, wherein:
the cloud server further includes a virtualization agent system,
the communication system of the cloud server is configured to communicate with a plurality of terminals, and
the virtualization agent system is configured to virtualize the cloud server, and generate and provide contents corresponding to each of the plurality of terminals.

5. The cloud system for a vehicle of claim 1, wherein the terminal further includes a database, and is configured to store the contents received from the cloud server.

6. A navigation terminal of a vehicle for communicating with a navigation cloud server, comprising:
an input for entering by a user a travel destination information;
a position recognition system for generating a current position information of the vehicle;
a communication system for communicating to the navigation server the entered travel destination information and the generated current position information; and
a display for displaying route information received via the communication system from the navigation server, which generates the route information based on the travel destination information and the current position information.

7. The navigation terminal of claim 6, wherein:
the navigation server includes a database (DB) for storing a user experience (UX) information and a server communication system, which communicates with the terminal communication system wirelessly; and
the navigation server generates contents including the UX information and transmits the contents to the navigation terminal, which displays the transmitted contents on the display.

8. The navigation terminal of claim 7, wherein:
the database of the navigation server is configured to further include map information; and
the navigation server retrieves map information corresponding to the received current position information from the database, generates contents including the map information and the UX information corresponding to the current position information, and transmits the contents to the navigation terminal.
